(19) United States
(12) Patent Application Publication
(10) Pub. No.: US 2010/0017522 A1
(43) Pub. Date: Jan. 21, 2010

(54) STREAMING ELECTRONIC CONTENT BETWEEN DISSIMILAR DOMAINS

(76) Inventors: Ian Burdick, Frisco, TX (US); Sathishkumar Gopalaswamy, Frisco, TX (US)

Correspondence Address: ERICSSON INC., 6300 LEGACY DRIVE, M/S EVR 1-C-11, PLANO, TX, 75024, US

(21) Appl. No.: 12/174,362

(22) Filed: Jul. 16, 2008

(51) Int. Cl. G06F 15/16

(52) U.S. Cl. 709/228

(57) ABSTRACT

A system, method, and streaming gateway for delivering a video stream between an IP Multimedia Subsystem (IMS) endpoint in an IMS domain and an Internet endpoint in an Internet domain. The streaming gateway sets up sessions in both the IMS and Internet domains. The IMS endpoint sends the video stream to the streaming gateway utilizing the Session Initiation Protocol (SIP) and Real Time Protocol (RTP), and the streaming gateway forwards the video stream to the Internet endpoint using an appropriate Internet protocol such as the Real Time Streaming Protocol (RTSP). The streaming gateway may also stream another video stream such as a promotional video to the Internet endpoint while waiting for the video stream from the IMS endpoint to become available.

### BACKGROUND OF THE INVENTION

The present invention relates to communication systems. More particularly, and not by way of limitation, the present invention is directed to a system, method, and streaming gateway for streaming electronic content between dissimilar domains such as an IP Multimedia Subsystem (IMS) domain and the Internet domain.

Content streaming on the Internet is very popular, and with the new deployments of IMS by operators there is a need to be able to stream content between the IMS domain and the Internet domain. However, existing systems and methods do not allow this to be done because sessions are set up utilizing different session protocols in each domain, and each protocol is applicable only in the domain for which it was developed. For example in the IMS domain, the Session Initiation Protocol (SIP) is used to set up sessions, and the Real Time Protocol (RTP) is used for real time media payload. In the Internet domain, there are many session protocols used such as Real Time Streaming Protocol (RTSP), Flash, and Windows Media.

### BRIEF SUMMARY OF THE INVENTION

It would be advantageous to have a system, method, and streaming gateway for interworking between dissimilar domains that overcomes the disadvantages of the prior art. The present invention provides a system, method, and streaming gateway that enables content streams to be delivered between the IMS and Internet domains using different methods of session setup.

The invention solves the problem of video streaming from the IMS domain into the Internet domain. It allows an IMS Endpoint to stream video to the Internet and thereby reach a vast audience. Additionally, the invention does not tie up IMS media resources until the Internet Endpoint User is ready to receive the video stream. In one embodiment, the Internet User may be shown promotional videos before and after the video stream, thus creating advertising opportunities for the service operator.

Thus, in one embodiment, the present invention is directed to a method for delivering a content stream from a first endpoint in a first domain to a second endpoint in a second, dissimilar domain, wherein communication sessions in the first and second domains are set up utilizing different protocols and procedures. The method includes the steps of providing a streaming gateway in communication with the first and second endpoints, wherein the streaming gateway is configured to set up sessions in both the first and second domains; setting up by the streaming gateway, a first session with the first endpoint utilizing the protocols and procedures of the first domain; and setting up by the streaming gateway, a second session with the second endpoint utilizing the protocols and procedures of the second domain. The method also includes receiving in the streaming gateway, the content stream from the first endpoint; and forwarding by the streaming gateway, the content stream to the second endpoint. In a specific embodiment, the first endpoint is an IP Multimedia Subsystem (IMS) endpoint in an IMS domain and the second endpoint is an Internet endpoint in an Internet domain. Additionally, while waiting for the content stream to become available from the IMS endpoint, the streaming gateway may stream another content stream such as a promotional video to the Internet endpoint.

In another embodiment, the present invention is directed to a streaming gateway for delivering a content stream from a first endpoint in a first domain to a second endpoint in a second, dissimilar domain, wherein communication sessions in the first and second domains are set up utilizing different protocols and procedures. The streaming gateway includes means for setting up a first session with the first endpoint utilizing the protocols and procedures of the first domain; means for setting up a second session with the second endpoint utilizing the protocols and procedures of the second domain; means for receiving the content stream from the first endpoint; and means for forwarding the content stream to the second endpoint. In a specific embodiment, the first endpoint is an IMS endpoint in an IMS domain and the second endpoint is an Internet endpoint in an Internet domain. The streaming gateway may also include means for streaming another content stream such as a promotional video to the Internet endpoint while waiting for the content stream from the IMS endpoint to become available.

In another embodiment, the present invention is directed to a system for delivering a content stream between first and second domains, wherein communication sessions in the first and second domains are set up utilizing different protocols and procedures. The system includes a streaming gateway configured to set up sessions in both the first and second domains; a first endpoint in the first domain for setting up a first session with the streaming gateway utilizing the protocols and procedures of the first domain; and a second endpoint in the second domain for setting up a second session with the streaming gateway utilizing the protocols and procedures of the second domain. The system also includes means within the first endpoint for utilizing the first session to send the content stream to the streaming gateway; and means within the streaming gateway for utilizing the second session to forward the content stream to the second endpoint. In a specific embodiment, the first endpoint is an IMS endpoint in an IMS domain and the second endpoint is an Internet endpoint in an Internet domain. The streaming gateway may also include means for streaming another content stream such as a promotional video to the Internet endpoint while waiting for the content stream from the IMS endpoint to become available.

### BRIEF DESCRIPTION OF THE SEVERAL VIEWS OF THE DRAWING

In the following section, the invention will be described with reference to exemplary embodiments illustrated in the figures, in which:

FIG. 1 is a simplified block diagram of an exemplary embodiment of a network architecture in which the present invention has been implemented;

FIG. 2 is a signaling diagram illustrating the signal flow for setting up and tearing down a session to deliver streaming content from an IMS Endpoint User to an Internet Endpoint User;

FIG. 3 is a flow chart illustrating the steps of an exemplary embodiment of the method of the present invention; and

FIG. 4 is a simplified block diagram of an exemplary embodiment of a Streaming Gateway.

### DETAILED DESCRIPTION OF THE INVENTION

The present invention provides a method for interworking between the IMS and Internet domains so that content can be streamed between the domains regardless of the protocols used in the Internet domain.

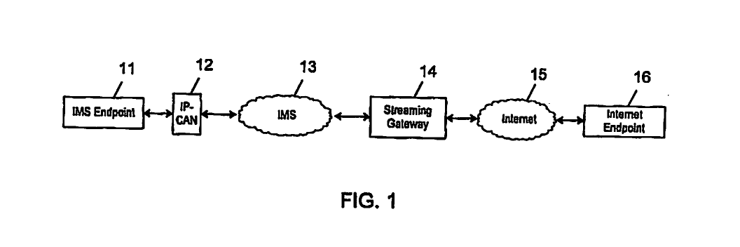

FIG. 1 is a simplified block diagram of an exemplary embodiment of a network architecture in which the present invention has been implemented. An IMS Endpoint 11 connects through an IP Connectivity Access Network (IP-CAN) 12 to an IMS network 13. The IMS network connects through a Streaming Gateway 14 to the Internet 15. An Internet Endpoint 16 connects to the Internet.

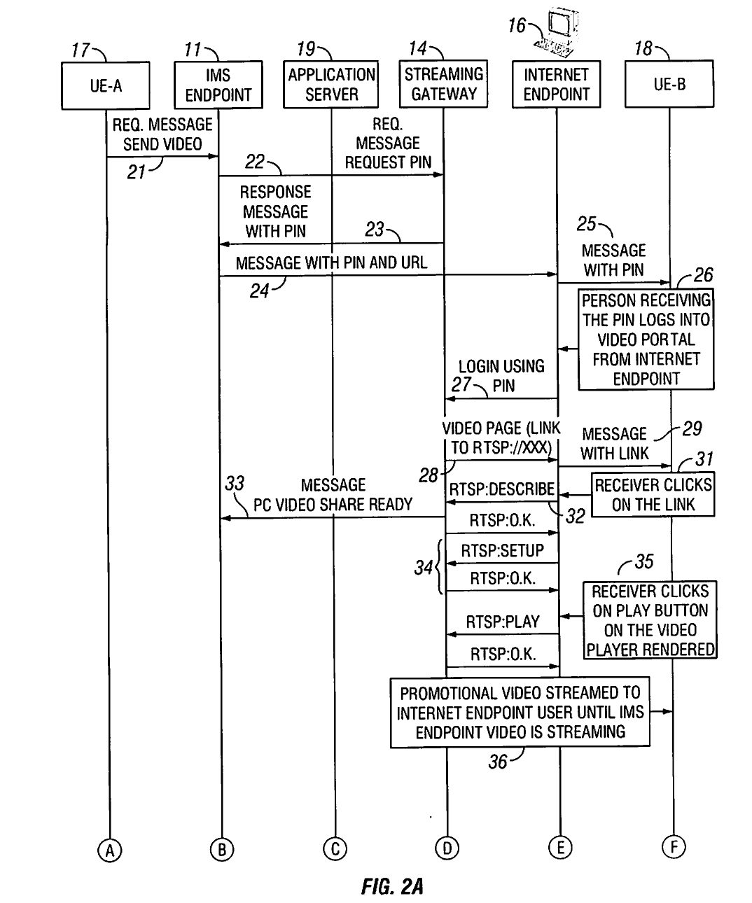

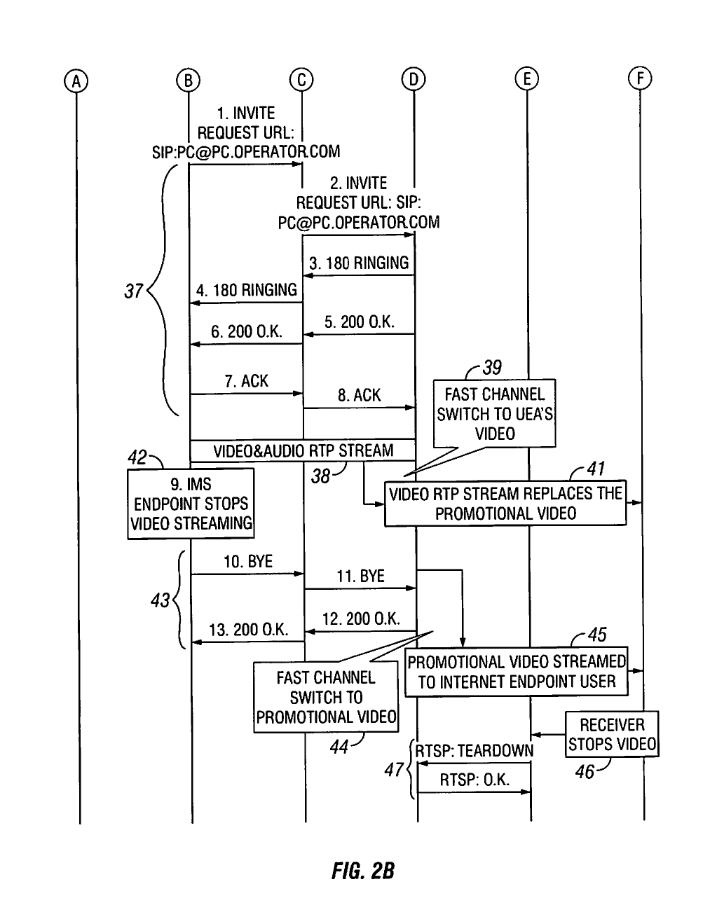

FIG. 2 is a signaling diagram illustrating the signal flow for setting up and tearing down a session to deliver streaming content from an IMS Endpoint User (UE-A) 17 to an Internet Endpoint User (UE-B) 18. UE-A sends a request message 21 to the IMS Endpoint 11 requesting to send a video to UE-B. The IMS Endpoint sends a request message 22 to the Streaming Gateway 14 requesting a one-time login Personal Identification Number (PIN). The Streaming Gateway returns the one-time login PIN in a response message 23. Upon receiving the response message, the IMS Endpoint sends a message 24 to the Internet Endpoint 16 with the PIN and the URL for UE-B 18. At 25, the Internet Endpoint sends the PIN to UE-B.

At 26, the UE-B user uses the PIN to log into a video portal through the Internet Endpoint 16. Upon receiving the PIN, the Internet Endpoint 16 sends a login message 27 to the Streaming Gateway 14 using the PIN. In an embodiment in which the Real Time Streaming Protocol (RTSP) is used to set up sessions in the Internet domain, the Streaming Gateway sends a video page 28 to the Internet Endpoint with a link to view a video in the form rtsp://xxx. The Internet Endpoint sends a message 29 with the link to UE-B, and at 31, the UE-B user clicks on the link. The Internet Endpoint then sends a Rtsp:DESCRIBE message 32 to the Streaming Gateway indicating that UE-B is ready to receive the video from UE-A 17.

The Streaming Gateway 14 then sends a PC Video Share Ready message 33 to the IMS Endpoint 11 with an indication that UE-B 18 is ready to receive video. At 34, the Internet Endpoint 16 and the Streaming Gateway also set up a temporary video connection to UE-B. At 35, the UE-B user clicks a Play button rendered on a video player, and at 36 the Streaming Gateway streams a video such as a promotional video to UE-B while waiting for the IMS Endpoint to initiate a video connection from UE-A 17. In the preferred embodiment, the Streaming Gateway interfaces with the IMS Endpoint through SIP signaling 37 while setting up a video and audio RTP stream 38 from UE-A.

When the Streaming Gateway 14 receives the video and audio RTP stream 38, the Streaming Gateway performs a fast channel switch at 39 to replace the promotional video and begin streaming UE-A's video and audio RTP stream to UE-B at 41.

At a later point in time 42, UE-A 17 stops sending the video and the IMS Endpoint 11 stops video streaming to the Streaming Gateway 14. SIP signaling 43 is used to alert the Streaming Gateway that the video session has ended. At 44, the Streaming Gateway performs another fast channel switch back to the promotional video, and at 45 the Streaming Gateway resumes streaming the promotional video to UE-B 18. At 46, the UE-B user stops the video, and the session with the Streaming Gateway is torn down at 47.

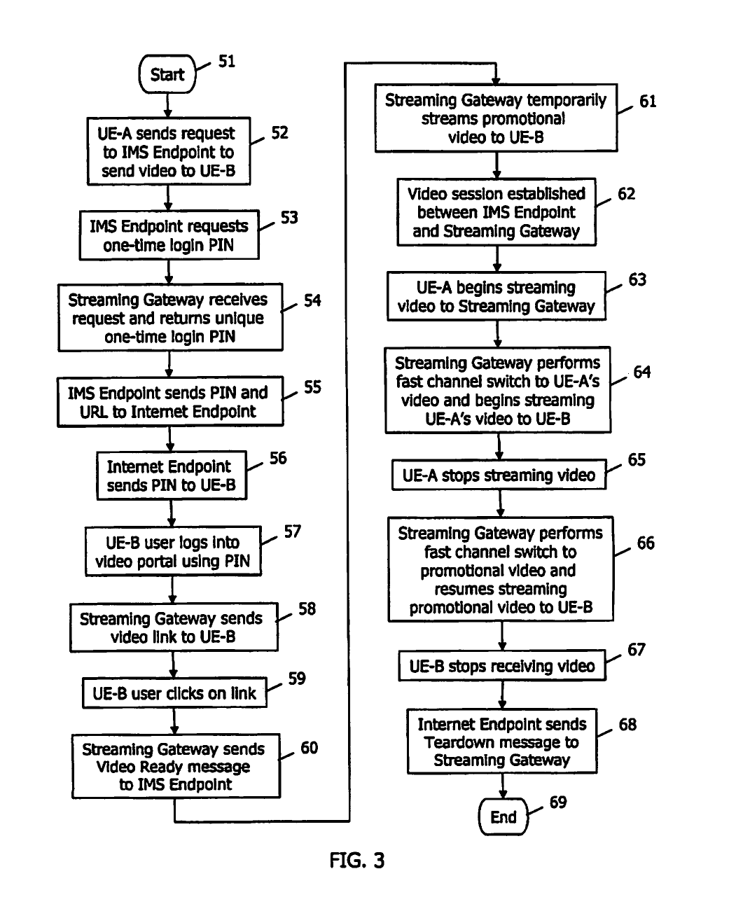

FIG. 3 is a flow chart illustrating the steps of an exemplary embodiment of the method of the present invention. The method starts at step 51. At step 52, UE-A 17 sends the request message 21 to the IMS Endpoint 11 requesting to send a video to UE-B 18. At step 53, the IMS Endpoint requests the one-time login PIN from the Streaming Gateway 14. At step 54, the Streaming Gateway receives the request and returns the unique one-time login PIN to UE-A. At step 55, the IMS Endpoint sends the PIN and the URL for UE-B to the Internet Endpoint 16. At step 56, the Internet Endpoint sends the PIN to UE-B.

At step 57, UE-B 18 uses the PIN to log into a video portal through the Internet Endpoint 16. Thus, the Internet Endpoint 16 logs into the Streaming Gateway 14 using the PIN. At step 58, the Streaming Gateway sends a video link to the Internet Endpoint, which forwards the link to UE-B. At step 59, the UE-B user clicks on the link, and the Internet Endpoint sends a Video Share Ready message to the Streaming Gateway indicating that UE-B is ready to receive the video from UE-A 17.

At step 61, the Streaming Gateway 14 may optionally set up a temporary video connection to UE-B 18 to temporarily stream a video such as a promotional video to UE-B while waiting for the IMS Endpoint 11 to set up a video and audio RTP stream from UE-A 17. At step 62, a video session is established between the IMS Endpoint and the Streaming Gateway, and at step 63, UE-A begins streaming video to the Streaming Gateway. At step 64, the Streaming Gateway receives the video and audio RTP stream and performs a fast channel switch to replace the promotional video and begin streaming UE-A's video and audio RTP stream to UE-B.

Later, at step 65, UE-A 17 stops streaming the video. At step 66, the Streaming Gateway 14 optionally performs another fast channel switch back to the promotional video and resumes streaming the promotional video to UE-B 18. At step 67, UE-B stops the video. At step 68, the Internet Endpoint sends a teardown message to the Streaming Gateway to end the session. The method ends at step 69.

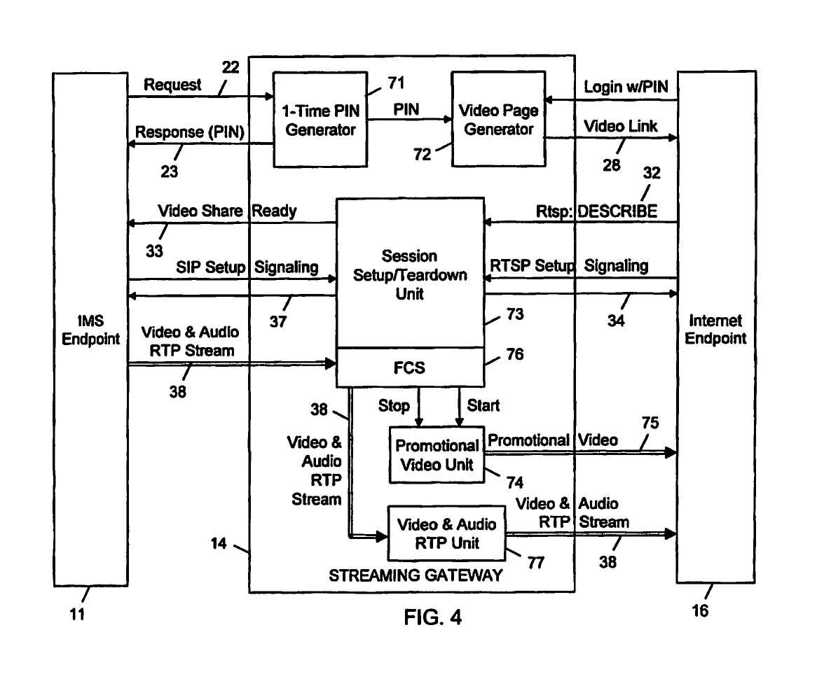

FIG. 4 is a simplified block diagram of an exemplary embodiment of a Streaming Gateway 14. In this embodiment, the Streaming Gateway interfaces with the IMS Endpoint 11 utilizing the SIP and RTP protocols, and interfaces with the Internet Endpoint 16 utilizing the RTSP protocol although other protocols may be utilized.

The Streaming Gateway 14 receives the request message 22 from the IMS Endpoint 11 and a 1-Time PIN Generator 71 generates a unique 1-time login PIN. The Streaming Gateway returns the one-time login PIN in the response message 23. The PIN is also shared with a Video Page Generator 72. The IMS Endpoint 11 then shares the PIN with the Internet Endpoint 16 and UE-B 18. When UE-B logs into the video portal, the Internet Endpoint sends the login message 27 to the Streaming Gateway 14 using the PIN. The Streaming Gateway then sends the video link to the Internet Endpoint in the video page 28. The Internet Endpoint forwards the link to UE-B, and when the UE-B user clicks on the link, the Internet Endpoint sends the Rtsp:DESCRIBE message 32 to a Session Setup/Teardown Unit 73 in the Streaming Gateway indicating that UE-B is ready to receive the video.

The Session Setup/Teardown Unit 73 then sends the PC Video Share Ready message 33 to the IMS Endpoint 11 with an indication that UE-B 18 is ready to receive video. While SIP signaling 37 is utilized to set up an IMS session between the Streaming Gateway 14 and the IMS Endpoint, the Session Setup/Teardown Unit utilizes RTSP signaling 34 to set up an RTSP session between the Streaming Gateway and the Internet Endpoint 16. When the UE-B user clicks a Play button rendered on a video player, the Session Setup/Teardown Unit determines whether the video and audio RTP stream from UE-A is ready to be delivered. If not, the Session Setup/Teardown Unit may start a Promotional Video Unit 74 to send a promotional video 75 to UE-B while waiting for the video and audio RTP stream to arrive.

When the Streaming Gateway 14 receives the video and audio RTP stream 38, a Fast Channel Switch (FCS) 76 stops the Promotional Video Unit 74 and activates a Video and Audio RTP Unit 77 to begin streaming the video and audio RTP stream to UE-B. Later, when the IMS Endpoint 11 stops video streaming to the Streaming Gateway 14, the Session Setup/Teardown Unit 73 tears down the IMS session between the Streaming Gateway and the IMS Endpoint 11. Optionally, the FCS may switch back to the Promotional Video Unit to resume streaming the promotional video 75 to UE-B. When the UE-B user stops the promotional video, the Session Setup/Teardown Unit 73 tears down the RTSP session between the Streaming Gateway and the Internet Endpoint 16.

The present invention addresses the issues of authentication and billing by leveraging the IMS infrastructure. The IMS Endpoint 11 that originates the video and audio RTP stream 38 must be a registered IMS user in order to use the service. Billing for the service may be handled by using standard IMS charging mechanisms.

In the embodiments described above, the present invention provides privacy by requiring the Internet Endpoint 16 to use the PIN 75 to log in before the video can be consumed. In an alternative embodiment, the requirement to use the PIN may be removed to provide public access without logging in.

In other embodiments, the present invention may also include value added features such as advertising inserted into videos, watermarking, or video storage.

In other embodiments, the present invention may utilize an interface enabling the Internet Endpoint to be a machine for incorporating the video into other applications (mashups) such as an electronic greeting card application.

In another embodiment, the present invention may interwork with IMS Endpoints that support packet-switched video and circuit-switched audio. In this embodiment, a combining unit in the Streaming Gateway 14 terminates the circuit-switched audio and combines it with the packet-switched video stream. This embodiment is useful for supporting existing Video Share clients that are in the marketplace today.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method for delivering a content stream from a first endpoint in a first domain to a second endpoint in a second, dissimilar domain, wherein communication sessions in the first and second domains are set up utilizing different protocols and procedures, said method comprising the steps of:
providing a streaming gateway in communication with the first and second endpoints, wherein the streaming gateway is configured to set up sessions in both the first and second domains;
setting up by the streaming gateway, a first session with the first endpoint utilizing the protocols and procedures of the first domain;
setting up by the streaming gateway, a second session with the second endpoint utilizing the protocols and procedures of the second domain;
receiving in the streaming gateway, the content stream from the first endpoint; and
forwarding by the streaming gateway, the content stream to the second endpoint.

2. The method as recited in claim 1, wherein the step of providing a streaming gateway includes providing a streaming gateway configured to set up sessions in both an IP Multimedia Subsystem (IMS) domain and an Internet domain.

3. The method as recited in claim 1, further comprising requiring an end user in the second domain to enter a Personal Identification Number (PIN) before setting up the second session with the second endpoint.

4. The method as recited in claim 1, further comprising the steps of:
determining by the streaming gateway, whether the content stream from the first endpoint is available for delivery when setup of the second session with the second endpoint is complete; and
if the content stream from the first endpoint is not available, temporarily delivering a second content stream to the second endpoint until the content stream from the first endpoint is available for delivery.

5. The method as recited in claim 4, wherein the step of temporarily delivering a second content stream includes performing a fast channel switch by the streaming gateway to deliver the content stream from the first endpoint when the content stream from the first endpoint becomes available.

6. The method as recited in claim 5, wherein the content streams are videos, and the step of temporarily delivering a second content stream includes temporarily delivering a promotional video to the second endpoint until the video from the first endpoint is available for delivery.

7. The method as recited in claim 6, further comprising the steps of:
determining by the streaming gateway that the video from the first endpoint is no longer being received and the first endpoint is ending the first session;
performing a fast channel switch by the streaming gateway to deliver the promotional video to the second endpoint; and
tearing down the first session.

8. The method as recited in claim 7, further comprising the steps of:
determining by the streaming gateway that the second endpoint is ending the second session; and
tearing down the second session.

9. A streaming gateway for delivering a content stream from a first endpoint in a first domain to a second endpoint in a second, dissimilar domain, wherein communication sessions in the first and second domains are set up utilizing different protocols and procedures, said streaming gateway comprising:
means for setting up a first session with the first endpoint utilizing the protocols and procedures of the first domain;
means for setting up a second session with the second endpoint utilizing the protocols and procedures of the second domain;
means for receiving the content stream from the first endpoint; and
means for forwarding the content stream to the second endpoint.

10. The streaming gateway as recited in claim 9, wherein the first endpoint is an IP Multimedia Subsystem (IMS) endpoint in an IMS domain and the second endpoint is an Internet endpoint in an Internet domain.

11. The streaming gateway as recited in claim 9, further comprising means for validating a Personal Identification Number (PIN) entered by an end user in the second domain before setting up the second session with the second endpoint.

12. The streaming gateway as recited in claim 9, further comprising:
means for determining whether the content stream from the first endpoint is available for delivery when setup of the second session with the second endpoint is complete; and
means for temporarily delivering a second content stream to the second endpoint if the content stream from the first endpoint is not available for delivery.

13. The streaming gateway as recited in claim 12, wherein the means for temporarily delivering a second content stream includes means for performing a fast channel switch to deliver the content stream from the first endpoint when the content stream from the first endpoint becomes available.

14. The streaming gateway as recited in claim 13, wherein the content streams are videos, and the second content stream is a promotional video.

15. The streaming gateway as recited in claim 14, further comprising:
means for determining that the video from the first endpoint is no longer being received and the first endpoint is ending the first session;
means for performing a fast channel switch to deliver the promotional video to the second endpoint; and
means for tearing down the first session.

16. The streaming gateway as recited in claim 15, further comprising:
means for determining that the second endpoint is ending the second session; and
means for tearing down the second session.

17. A system for delivering a content stream between first and second domains, wherein communication sessions in the first and second domains are set up utilizing different protocols and procedures, said system comprising:
a streaming gateway configured to set up sessions in both the first and second domains;
a first endpoint in the first domain for setting up a first session with the streaming gateway utilizing the protocols and procedures of the first domain;
a second endpoint in the second domain for setting up a second session with the streaming gateway utilizing the protocols and procedures of the second domain;
means within the first endpoint for utilizing the first session to send the content stream to the streaming gateway; and
means within the streaming gateway for utilizing the second session to forward the content stream to the second endpoint.

18. The system as recited in claim 17, wherein the first endpoint is an IP Multimedia Subsystem (IMS) endpoint in an IMS domain and the second endpoint is an Internet endpoint in an Internet domain.

19. The system as recited in claim 18, wherein the content stream is a video stream and the streaming gateway also includes:
means for determining whether the video stream from the IMS endpoint is available for delivery when setup of the second session with the Internet endpoint is complete;
means for temporarily delivering a promotional video to the Internet endpoint if the video stream from the IMS endpoint is not available for delivery; and
means for performing a fast channel switch to deliver the video stream from the IMS endpoint when the video stream from the IMS endpoint becomes available.

20. The system as recited in claim 19, wherein the streaming gateway also includes:
means for determining that the video stream from the IMS endpoint is no longer being received and the IMS endpoint is ending the first session;
means for performing a second fast channel switch to deliver the promotional video to the Internet endpoint; and
means for tearing down the first session.

21. The system as recited in claim 20, wherein the streaming gateway also includes:
means for determining that the Internet endpoint is ending the second session; and
means for tearing down the second session.
